(19) United States
(12) Patent Application Publication
(10) Pub. No.: US 2026/0303340 A1
(43) Pub. Date: Oct. 1, 2026

(54) SECURE KEY COMPONENT EXCHANGE

(71) Applicant: ENTRUST CORPORATION, Shakopee, MN (US)

(72) Inventors: Kent Landerholm, Apple Valley, MN (US); Evan Vaala, Eden Prairie, MN (US)

(21) Appl. No.: 19/576,158

(22) Filed: Mar. 24, 2026

Related U.S. Application Data
(60) Provisional application No. 63/777,507, filed on Mar. 25, 2025.

(51) Int. Cl. H04L 9/08; G06F 21/36

(52) U.S. Cl. CPC H04L 9/0877; G06F 21/36; H04L 9/0825

(57) ABSTRACT

Methods and systems for establishing a secure communication channel with a hardware security module (HSM) are provided. A HSM generates a custom certificate including non-sensitive information associated with the HSM. A key manager generates a machine-readable code including the custom certificate and displays the machine-readable code on a display. A key loading device (KLD) can scan the machine-readable code. The KLD can extract the custom certificate and use the non-sensitive information to establish a secure connection with the HSM. Alternately, the custom certificate can be encrypted by the HSM with a key that is provided to the KLD for decryption at a secure system. Accordingly, a secure connection for a key ceremony can be established without manual data entry or exchange of HSM configuration details over a network connection.

### CROSS-REFERENCE TO RELATED APPLICATIONS

This application claims priority to U.S. Provisional Patent Application No. 63/777,507, filed Mar. 25, 2025, the entire disclosure of which is hereby incorporated by reference.

### TECHNICAL FIELD

Embodiments relate to secure data transfer between a hardware security module (HSM) and a secure computing device, such as a key loading device (KLD). More particularly, embodiments allow the secure computing device to connect and establish mutual trust with the HSM to secure the exchange of clear key components.

### BACKGROUND

As reliance on computer-based infrastructures and mobile devices increases, a need often arises for a computing device, such as a server or terminal, to access specific data or files from a mobile device. For example, a computing device may require user-associated data stored on a mobile device for authentication, processing, or operational purposes. Conventional data transfer techniques, including wired connections (e.g., USB) and wireless protocols (e.g., WiFi, NFC), may be impractical, particularly with terminal-based computing environments that have hardware limitations. In certain contexts, terminals may lack user interfaces and physical connection ports, and data transfer over a network can introduce security risks.

Cryptographic key management, particularly in the context of financial transactions and secure authentication systems, is one area where secure data transfer is challenging. Payment Card Industry (PCI) standards require that cryptographic keys be divided into multiple key components, each held by a separate key custodian. The individual key component held by each custodian cannot reveal the complete key value when viewed in isolation. Rather, these key components must be securely combined at a hardware security module (HSM) to form a master key, which is then used for encryption or authentication purposes. For instance, financial institutions commonly receive smart cards that are locked with a master key, which must be authenticated by an HSM before the cards can be used.

The process of generating key components to prepare them for transfer to key custodians is often referred to as a key “ceremony.” The key ceremony requires precise management and transfer of data between systems within the computing environment. Modern PCI standards dictate that key components must be loaded into an HSM using a secure computing device (e.g., a FIPS device) as use of a non-secure system (e.g., software) or a non-secure computing device to load key components can compromise secrecy. Accordingly, key ceremonies involve the secure exchange of data between an HSM, a key manager, and a secure device. Coordinating trust and establishing a secure connection between these devices is often cumbersome and inefficient. For example, manual entry of information necessary for establishing a secure exchange, such as an IP address or a public key associated with the HSM, at the secure device may be required.

Remote transmission of key components (e.g., when recreating a key) is also problematic, as key components are often stored in cleartext, making them vulnerable to interception. Therefore, key custodians are typically required to be physically present at the HSM to manually input their respective key components. In some cases, a custodian may securely transmit their key component to a proxy who is physically present at the HSM and can manually enter the key component on their behalf. This process is typically conducted sequentially, with each custodian sending their key component, awaiting confirmation, and repeating the process until all components are entered.

Key loading, the process of transferring key components from a trusted source (e.g., HSM, key manager) to a target device (e.g., another HSM, payment terminal, smartcard) to enable encryption operations, was traditionally performed manually using a dumb terminal (e.g., a keyboard or keypad) integrated with the target device. This process relied on physical security controls and procedural safeguards, but posed risks, including key exposure to unauthorized personnel, interception during loading, and the potential for tampering.

To mitigate these risks, PCI security standards now require the use of a separate secure device for key loading. For example, during key loading key custodians may enter the key component into a key loading device (KLD) for secure transfer to the HSM and during key extraction the key component may be extracted from the KLD. These KLDs may be designed with tamper-resistant features, enforce strict controls like dual control and split knowledge, and use encryption to protect keys during transfer. While KLDs can reduce the risk of key compromise from fraud, man-in-the-middle attacks, and regulatory non-compliance, establishment of a connection and mutual trust between the KLD and HSM is often error-prone, cumbersome, and inefficient.

As the number of key components increases and industry standards evolve, the logistical and security challenges of the key generation and management process, including key loading, become even more pronounced.

### SUMMARY

The present disclosure relates generally to methods and systems for establishing a secure communication channel between two secure cryptographic devices, such as between a hardware security module (HSM) and a key loading device (KLD). The methods and systems described herein allow KLDs to, for example, collect key components offline, connect to the HSM, establish mutual trust with the HSM, and secure the exchange of clear components between the KLD and HSM, thereby simplifying the traditional key ceremony required to generate or extract a secure key in certain (e.g., PCI) environments.

In a first aspect, a method of establishing a secure connection for a key ceremony is disclosed. The method includes generating, at a hardware security module (HSM), a custom certificate including an attribute associated with the HSM, displaying, at a key manager, the custom certificate as a machine-readable code, scanning the machine-readable code with a key loading device (KLD), and extracting, at the KLD, the attribute associated with the HSM from the scanned machine-readable code to establish a secure connection between the HSM and the KLD using the attribute. The secure connection is configured to support the exchange of clear key components. For example, the secure connection may be a transport layer security (TLS) connection.

In some embodiments, the custom certificate is encrypted by the HSM. In such embodiments, the KLD can use a stored private key (e.g., associated with the HSM) to decrypt the custom certificate. The custom certificate can consist of non-sensitive information, such as an IP address or a public key associated with the HSM.

In some embodiments, the machine-readable code is one of a barcode or a QR code.

In some embodiments, the method further comprises establishing mutual trust between the KLD and the HSM based on the extracted attribute.

In some embodiments, the display of the machine-readable code by the key manager is responsive to a received indication at the key manager. For example, the received indication may specify a particular HSM from a set of HSMs communicatively coupled to the key manager. The key manager can be configured to display a unique machine-readable code for each HSM in the set of HSMs.

In a second aspect, a key management system is disclosed. The key management system includes a HSM comprising a processor configured to generate a custom certificate including non-sensitive information associated with the HSM, a key manager device communicatively coupled to the HSM and comprising a display and a processor configured to generate a machine-readable code of the custom certificate, and a key loading device comprising an optical reader and a processor configured to scan the machine-readable code using the optical reader, extract the non-sensitive information from the machine-readable code, and establish a secure connection with the HSM using the non-sensitive information. The key manager selectively displays the machine-readable code on the display in response to a key ceremony request.

In a third aspect, a method of establishing a secure connection for a key ceremony is disclosed. The method includes generating, at each hardware security module (HSM) of a plurality of HSMs, a custom certificate including non-sensitive information associated with the respective HSM, receiving, at a key manager, a request to generate a set of key components, wherein the request includes an indication of an HSM of the plurality of HSMs, generating, by the key manager, a machine-readable code encoding the custom certificate associated with the HSM, displaying, by the key manager, the machine-readable code, scanning the machine-readable code with a key loading device (KLD), decoding, at the KLD, the non-sensitive information associated with the HSM from the scanned machine-readable code, and initiating, from the KLD, a secure connection with the HSM based on the non-sensitive information, wherein the secure connection is configured to support the exchange of the set of key components.

### BRIEF DESCRIPTION OF THE DRAWINGS

Subject matter hereof may be more completely understood in consideration of the following detailed description of various embodiments in connection with the accompanying figures, in which:

FIG. 1 is a system diagram of a system for managing cryptographic keys, according to an embodiment.

FIG. 2 is a block diagram of a hardware security module, according to an embodiment

FIG. 3 is a block diagram of a computing device, according to an embodiment.

FIG. 4 is a flowchart of a method for establishing a secure symmetric communication channel, according to an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

Embodiments of the present disclosure are generally directed to methods and systems for streamlining management of key ceremonies. As used herein, the term key ceremony refers to creating a plurality of key components (e.g., shares) of a key, for example to prepare key components for transfer to a plurality of key custodians, and/or combining a plurality of received key components to recreate the key. In some instances, the key may be a symmetric key used by the HSM. A key component, in this context, is a value from among a set of n values (where n is greater than 1) that, when combined, form a value of a secret key. Any subset of fewer than n values does not reveal the secret key, however once all of the n values are aggregated, the key may be recreated (e.g., by an HSM).

Methods and systems for key entry and extraction, including for remote asynchronous key entry, are described in commonly owned U.S. Pat. No. 11,856,088 (U.S. patent application Ser. No. 17/190,084) titled REMOTE ASYNCHRONUS KEY ENTRY, filed on Mar. 2, 2021, which is herein incorporated by reference in its entirety.

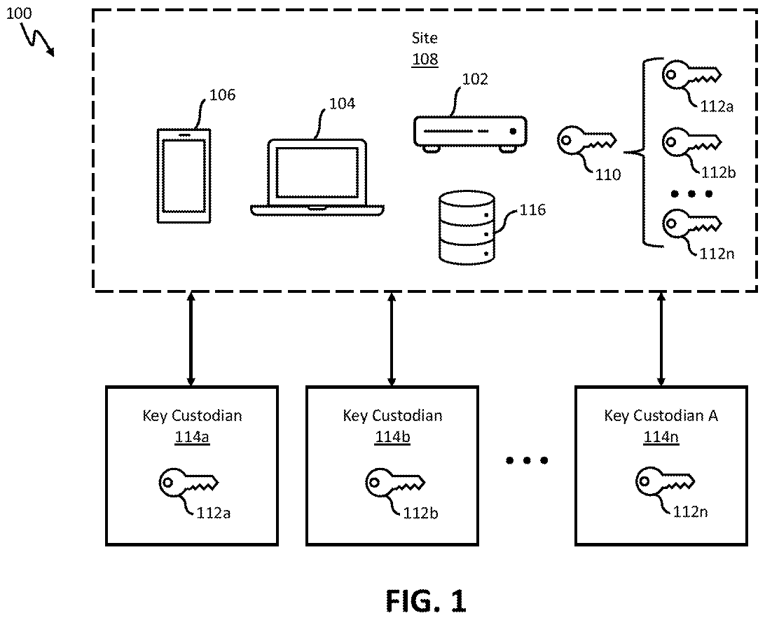

Referring to FIG. 1, a block diagram of a system 100 for managing cryptographic keys is depicted, according to an embodiment. System 100 generally includes an HSM 102, a key manager 104, a secure device 106, and a secure storage 116 at a site 108 (e.g., a common physical location) and key custodians 114. In embodiments, system 100 is configured to conduct key ceremonies for a cryptographic key 110 stored in secure storage 116. For example, key 110 may be reconstituted from key components 112a-n (e.g., received from key custodians 114a-n).

HSM 102 is configured to securely generate, store, and manage digital keys (e.g., symmetric keys and asymmetric keys). For example, HSM 102 can perform cryptographic operations (e.g., encryption, decryption, signing) related to cryptographic key 110.

Key manager 104 acts as a central authority that handles key distribution and policy enforcement for HSM 102, for example, by allowing users to connect with and control HSM 102. Key manager 104 can display parameters of HSM 102 that can be used by secure device 106 to establish a secure exchange with HSM 102. This information can include both sensitive and non-sensitive information associated with HSM 102. In the context of key ceremonies and HSMs, non-sensitive information refers to data that does not compromise the security or integrity of cryptographic keys or the ceremony process if disclosed. Examples include the procedural steps for the ceremony and general configuration details of the HSM without revealing critical security parameters. In some instances, non-sensitive information associated with an HSM can include one or more of an IP address, a hostname, a port number, a public key (e.g., for key wrapping), a transport layer security (TLS) configuration (e.g., TLS certificates, trusted certificate authority chain), or device-specific hardware identifiers.

Key manager 104 includes a display configured to output video information (e.g., a video interface). In embodiments, the display can be various types of devices for displaying video information, such as an LCD display panel, a plasma screen display panel, a touch-sensitive display panel, an LED screen, a cathode-ray tube display, or a projector. The display can be configured to receive user input.

In some embodiments, key manager 104 interfaces with multiple HSMs (e.g., a set of HSMs). For example, key manager 104 may interface with a different HSM depending on the desired application (e.g., database encryption, TLS key management).

As illustrated, key manager 104 is a dedicated device located at site 108. In some embodiments, key manager 104 is a remotely accessible server application. For example, key manager 104 can be a web-based application.

Secure device 106 is a secure computing device configured to support the secure exchange of key components during key ceremonies. In some embodiments secure device 106 is an audit device, air-gapped transfer device, a quorum authentication device, or a key loading device. For example, secure device 106 may be configured to log key ceremony steps to verify compliance or detect anomalies, move cryptographic materials between isolated systems, or facilitate multi-party authorization before key activation. In some embodiments, secure device 106 is plugged into a switch within a logically secure or physically secure network.

Secure device 106 includes an optical reader configured to read machine-readable codes. For example, the optical reader can be a barcode reader or a QR code reader. In some embodiments, the optical reader is a camera.

In example embodiments, secure device 106 is a key loading device (KLD) that provides a user interface for securely entering or viewing the clear components of a secret key. KLDs may be used for injecting a secret key into, or extracting a secret key from, an HSM via clear components of that key. This exchange depends on a trusted relationship between the KLD and the HSM. In practice, KLDs can reduce the risk of exposure, manipulation, or interception of key components 112 during key injection or provision, for example, compared to conventional approaches such as use of a dumb terminal.

In accordance with the present disclosure, secure device 106 can be a handheld KLD that can securely transfer received key components to an appropriate HSM. For example, the KLD can include a keypad, touchscreen, or other interface that a user can manually enter (e.g., type) key components into (e.g., during a key ceremony or key extraction). The KLD can (e.g., then) securely transfer the key components to the HSM. In some embodiments, the KLD has a private key to decrypt transferred information (e.g., for added protection).

As illustrated, each key component 112a-n has an associated key custodian 114a-n. In embodiments, there are two or more key components 112 and respective key custodians 114. In some instances, key custodians 114a-n are located at site 108. In other instances, key custodians 114a-n are at a common physical location remote from site 108. Key custodians 114a-n can be located at one or more different locations. The locations may be, for example, different locations of an organization. In embodiments, a key custodian 114 can communicate with key manager 104.

In some embodiments, a user, or a quorum of users having shared control, is authorized to generate secret keys and enable extraction of keys (e.g., from HSM 102) via key manager 104 and secure device 106. In a particular example, the user has specific authority to generate secret keys from key components and enable extraction via key components. The user may also have authority to facilitate key injection (e.g., corresponding to generation of a secret key within a HSM for a secret key protected by that HSM).

In operation, keys are associated with a client and used to perform one or more cryptographic functions embodied in the firmware on HSM 102. When a client request in the form of a command is received at HSM 102, the relevant application key(s) are retrieved and loaded into working memory (e.g., the RAM space of the firmware process). The application keys can then be used by HSM 102 to perform one or more cryptographic operations. In some embodiments, digital keys are stored on HSM 102 in persistent storage.

In some embodiments, keys are stored in an encrypted manner externally to the HSM 102 and loaded onto HSM 102 when required for performing a particular cryptographic operation. For example, application keys can be stored on smartcards. A digital key can be encrypted by an HSM key and subsequently split across multiple smart cards using secret sharing schemes that allow a quorum of the smartcards to reconstruct the original digital key (e.g., for greater security).

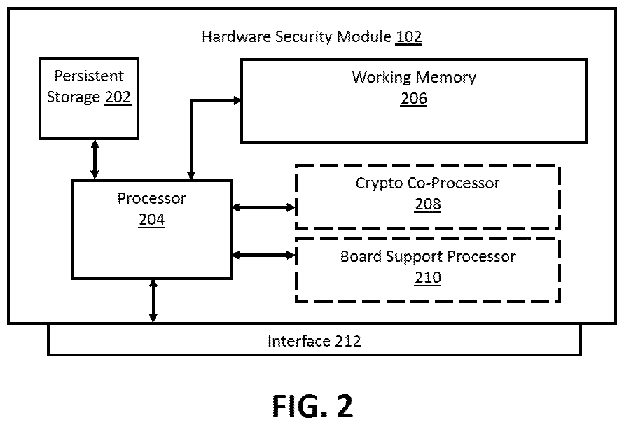

Referring to FIG. 2, a system diagram of an HSM 102 is depicted, according to an embodiment. HSM 102 is a computing device that securely stores and manages cryptographic keys. For example, HSM 102 can perform cryptographic functions related to encryption, decryption, authentication, and digital signing. HSM 102 generally comprises a persistent storage 202, a processor 204, a working memory 206, and an interface 212.

Persistent storage 202 can comprise non-volatile storage to store information, such as cryptographic keys and programs. Persistent storage 202 can include various form(s) of non-volatile device memory such as flash, optical disks, or magnetic hard drives.

Processor 204 is configured to execute programs (e.g., a set of computer instructions stored in persistent memory 202). One or more programs may be referred to as firmware. Firmware generally comprises computer instructions embodying one or more of the methods, for example, to provide low-level control and functionality and may be written in any of a number of programming languages. Firmware can comprise computer instructions embodying one or more of the following cryptographic functions: cryptographic key generation, key derivation, encryption, decryption, or digital signature functions (e.g., digital signing or validation of a digital signature).

In some embodiments, processor 204 is a central processing unit (CPU) in wired bi-directional communication with other components of HSM 102 (e.g., persistent storage 202, working memory 206). Working memory 206 corresponds to the operating memory of processor 204 and can be random-access memory (RAM). Processor 204 comprises logic circuitry that responds to and processes the instructions in code stored in the working memory 206. In particular, when executed, a program is represented as a process stored in working memory 206. Firmware can be embedded in HSM 102 when manufactured, or can be provided, as a whole or in part, after manufacture. For instance, firmware can be introduced as a computer program product, which may be in the form of a download. Modifications to firmware previously embedded in HSM 102 can be made, for example, by an update or plug-in. Execution of various programs by processor 204 can implement the methods described herein.

In some embodiments, HSM 102 includes physical properties that provide security. Physical security properties can include tamper switches triggered by physical access, and a tamper proof membrane surrounding the physical boundary of the device. For example, persistent memory 202 can be physically secure and tamper-resistant by the inclusion of a physical membrane that covers the chassis of HSM 102 and cannot be removed (e.g., by a third party) without destroying the underlying physical hardware.

As illustrated, HSM 102 can optionally comprise further components, such as a cryptographic co-processor 208 and a board support processor 210. Cryptographic co-processor 208 is configured to perform certain cryptographic functions (e.g., instead of processor 204). Board support processor 210 is configured to communicate with on-board sensor(s) to monitor the operation of components within HSM 102. Integrated sensors can include, for example, CPU and/or board temperature sensors, voltage and/or current sensors.

HSM 102 can be communicatively coupled to a key manger via interface 212. Interface 212 comprises a communication link and can be used for communication with HSM 102 (e.g., sending commands and receiving replies). Interface 212 can act as a conduit for any network communication, such as with a host server. In some implementations, HSM 102 communicates over an encrypted and authenticated secure channel, such as a PCI Express or USB connection. A host server can (e.g., also) be contained within a tamper-evident chassis and not user-serviceable. In some embodiments, HSM 102 and a host server share a chassis.

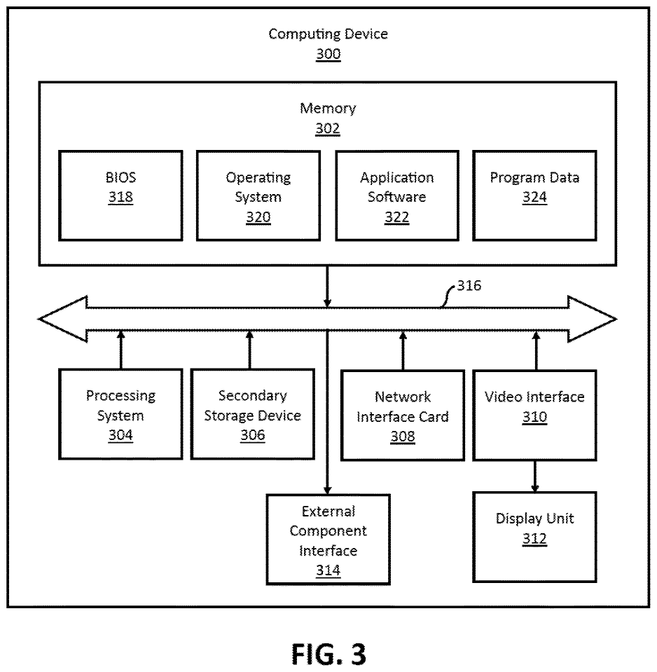

Referring to FIG. 3, a block diagram of a computing device 300 on which aspects of the present disclosure may be implemented is depicted, according to an embodiment. Computing device 300 can be used, for example, to implement computing devices such as key manager 104, secure device 106, or key custodian 114 as described in connection with FIG. 1. In the example of FIG. 3, computing device 300 includes a memory 302, a processing system 304, a secondary storage device 306, a network interface card 308, a video interface 310, a display unit 312, an external component interface 314, and a communication medium 316.

Memory 302 includes one or more computer storage media capable of storing data and/or instructions. In different embodiments, memory 302 is implemented in different ways. For example, memory 302 can be implemented using various types of computer storage media and generally includes tangible media. In some embodiments, memory 302 is implemented using entirely non-transitory media.

Processing system 304 includes one or more processing units, or programmable circuits. A processing unit is a physical device or article of manufacture comprising one or more integrated circuits that selectively execute software instructions. In various embodiments, processing system 304 is implemented in various ways. For example, processing system 304 can be implemented as one or more physical or logical processing cores. In another example, processing system 304 can include one or more separate microprocessors. In yet another example embodiment, processing system 304 can include an application-specific integrated circuit (ASIC) that provides specific functionality. In yet another example, processing system 304 provides specific functionality by using an ASIC and by executing computer-executable instructions.

Secondary storage device 306 includes one or more computer storage media. Secondary storage device 306 stores data and software instructions not directly accessible by processing system 304. In other words, processing system 304 performs an I/O operation to retrieve data and/or software instructions from secondary storage device 306. In various embodiments, secondary storage device 306 includes various types of computer storage media. For example, secondary storage device 306 can include one or more magnetic disks, magnetic tape drives, optical discs, solid-state memory devices, and/or other types of tangible computer storage media.

Network interface card 308 allows computing device 300 to send data to and receive data from a communication network. In different embodiments, network interface card 308 is implemented in different ways. For example, network interface card 308 can be implemented as an Ethernet interface, a fiber optic network interface, a wireless network interface (e.g., WiFi, Bluetooth, etc.), or another type of network interface.

Video interface 310 and display unit 312 may be optionally included in computing device 300. In such optional embodiments, video interface 310 enables computing device 300 to output video information to display unit 312. Display unit 312 can be various types of components for displaying video information, such as an LCD display panel, a plasma screen display panel, a touch-sensitive display panel, an LED or OLED screen, a cathode-ray tube display, or a projector. Video interface 310 can communicate with display unit 312 in various ways, such as via a Universal Serial Bus (USB) connector, a VGA connector, a digital visual interface (DVI) connector, an S-Video connector, a High-Definition Multimedia Interface (HDMI) interface, or a DisplayPort connector.

External component interface 314 enables computing device 300 to communicate with external devices. For example, external component interface 314 can be a USB interface and/or another type of interface that enables computing device 300 to communicate with external devices or peripheral devices integrated within the same housing (e.g., in the case of mobile devices). In various embodiments, external component interface 314 enables computing device 300 to communicate with various external components, such as external storage devices, input devices, speakers, modems, media player docks, other computing devices, scanners, digital cameras, and fingerprint readers.

Communication medium 316 facilitates communication among the hardware components of computing device 300. Communication medium 316 facilitates communication among memory 302, processing system 304, secondary storage device 306, network interface card 308, video interface 310, and external component interface 314. Communication medium 316 can be implemented in various ways. For example, communication medium 316 can include a PCI bus, a PCI Express bus, an accelerated graphics port (AGP) bus, a serial Advanced Technology Attachment (ATA) interconnect, a parallel ATA interconnect, a Fiber Channel interconnect, a USB bus, a Small Computing system Interface (SCSI) interface, or another type of communications medium.

Memory 302 stores various types of data and/or software instructions. Memory 302 stores a Basic Input/Output System (BIOS) 1118 and an operating system 320. BIOS 318 includes a set of computer-executable instructions that, when executed by processing system 304, cause computing device 300 to boot up. Operating system 320 includes a set of computer-executable instructions that, when executed by processing system 304, cause computing device 300 to provide an operating system that coordinates the activities and sharing of resources of computing device 300. Furthermore, memory 302 stores application software 322. Application software 322 includes computer-executable instructions, that when executed by processing system 304, cause computing device 300 to provide one or more applications. In an example, memory 302 stores application software 322 for an SDK. Memory 302 also stores program data 324. Program data 324 is data used by programs that execute on computing device 300.

In some embodiments of computing device 300, the computer-readable instructions are stored on devices that include non-transitory media. In particular embodiments, the computer-readable instructions are stored entirely on non-transitory media.

Although particular features are discussed herein as included within computing device 300, it is recognized that in certain embodiments not all such components or features may be included within a computing device according to the methods and systems of the present disclosure. Furthermore, different types of hardware and/or software systems could be incorporated into such an electronic computing device.

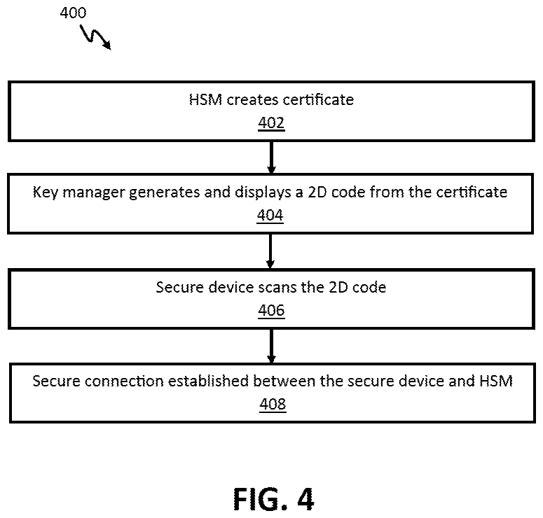

Referring now to FIG. 4, a flowchart of a method 400 for establishing a symmetric communication channel between a key loading device and an HSM using a scannable code is depicted, according to embodiment. In embodiments, the methods described with respect to FIG. 4 may be performed, for example, within the environments described herein with respect to FIGS. 1-3.

At 402, an HSM creates a custom certificate that includes data that can be used to securely exchange key components. In some instances, the certificate is encrypted by the HSM. The custom certificate can, for example, include one or more of a version identifier, a HSM serial number, a KLD serial number, a HSM type, key ceremony properties (e.g., identifier, type-entry or extraction), key properties (e.g., identifier, type, size, number of components), a cryptographic token identifier, session key derivation data, or connection parameters (e.g., IP address or a public key).

At 404, a key manager generates a machine-readable code, such as a barcode or QR code, based on the custom certificate. In embodiments, the machine-readable code contains all information of the custom certificate. In such embodiments, no sensitive information, such as seed data, is included in the machine-readable code.

The key manager then displays the machine-readable code on a secure screen. In some instances, the secure screen will be located in close proximity to the HSM such that only users physically present at a secure site associated with the HSM can scan the code.

At 406, a secure device (e.g., KLD) scans the machine-readable code generated by the key manager to extract data. The secure device may, for example, be equipped with a camera or QR code scanner, to scan the machine-readable code. The scanning process can be done offline, ensuring that the initial exchange of information is not exposed to network-based threats. Optionally, extracted data may be verified, such as by checking a certificate associated with the HSM against a trusted root certificate authority.

At 408, a secure connection is established between the secure device (e.g., KLD) and the HSM based on the information obtained from the machine-readable code. The secure connection can be used to establish mutual trust and secure the exchange of clear components between the secure device and the HSM. For example, once mutual authentication is successful, a session key can be generated for encrypting further communications.

In embodiments, the secure connection is a transport layer security (TLS) connection. A TLS connection may be established using a public key or shared secret included in the machine-readable code. During the key exchange process, the TLS connection can safeguard the transmission of sensitive key material. For example, the TLS connection would protect the exchange of key components during a key ceremony, ensuring compliance with PCI requirements.

In operation, bootstrapping the secure connection process for a key ceremony provides significant advantages by improving operational efficiency, reducing the likelihood of human error, and ensuring the consistent application of security protocols.

In some embodiments, a onetime keypair is generated to be used when establishing a first round of trust between the HSM and the KLD. The private key of the generated keypair can be embedded into a persistent storage of the KLD at the time of manufacture. The public key of the generated keypair can then be used to encrypt a custom certificate to be sent to the KLD (e.g., via a machine-readable code) and to verify a KLD certificate received by the HSM (e.g., to establish trust). In other embodiments, the custom certificate can be sent to the KLD unencrypted.

The custom certificate sent to the KLD can include a serial number of the KLD and an intended IP address. When the KLD receives the custom certificate, the custom certificate information can be displayed by the KLD for visual verification. Upon verification, the KLD will open a socket connection to the HSM using the provided IP address. The custom certificate can later be used to encrypt symmetric key derivation data sent to HSM.

In some embodiments, the custom configuration certificate sent to the KL can include additional fields, including the KLD serial number, the IP address of the HSM, the HSM serial number, a public key of the HSM, an operation session ID, and an indication whether the trust algorithm is approved. For example, the custom certificate can indicate to disable KLD to HSM trust the HSM firmware deprecates the current trust algorithm.

In some embodiments, a temporary keypair is generated by the HSM at the beginning of a key component operation. This keypair may be used to establish a temporary one-way KLD to HSM encryption channel. For example, the public key of the temporary keypair generated by the HSM can be included in the configuration certificate sent to the KLD. The private key of the temporary keypair can reside on the HSM to decrypt subsequent trust messaging received from the KLD.

In some embodiments, a temporary keypair is generated by the KLD after receiving a channel initialization packet. The keypair may be used to establish a temporary one-way HSM to KLD encryption channel. For example, the public key of the temporary keypair generated by the KLD can be passed to the HSM via a certificate. The private key can temporarily reside on the KLD to decrypt subsequent trust messaging received from the HSM.

In some embodiments, once a secure channel is established between the HSM and KLD, key derivation data can be randomly generated by the KLD and supplied to the HSM.

Embodiments of the present disclosure improve traditional key management workflows through use of machine-readable codes for exchange of non-sensitive HSM data. Generation of machine-readable codes including information such as a public key or an IP address of the HSM allows for reliable distribution of key components during a key ceremony while mitigating the delays and security risks associated with manual handling. Automation of key ceremony tasks allows organizations to handle larger volumes of cryptographic operations without compromising security

Embodiments of the present disclosure allow for key ceremony management without exporting or exposing cleartext keys. Exposure of encryption information, including encryption keys, to systems and entities outside a secure site associated with the HSM may compromise the protected data. Advantageously, the systems and methods disclosed herein address this problem by allowing for the offline transfer of information needed to structure communications between a KLD and an HSM.

The figures and foregoing description relate to embodiments by way of illustration only. It should be noted that from the foregoing discussion, alternative embodiments of the structures, systems, and methods disclosed herein will be readily recognized as viable alternatives that may be employed without departing from the principles of what is claimed.

What is claimed is:

1. A method of establishing a secure connection for a key ceremony, the method comprising:
generating, at a hardware security module (HSM), a custom certificate including an attribute associated with the HSM;
displaying, at a key manager, the custom certificate as a machine-readable code;
scanning the machine-readable code with a key loading device (KLD);
extracting, at the KLD, the attribute associated with the HSM from the scanned machine-readable code; and
establishing a secure connection between the HSM and the KLD using the attribute, wherein the secure connection is configured to support the exchange of clear components.

2. The method of claim 1, wherein the custom certificate is encrypted by the HSM.

3. The method of claim 2, wherein extracting the attribute associated with the HSM comprises decrypting, at the KLD, the custom certificate using a private key stored on the KLD.

4. The method of claim 1, wherein the machine-readable code is one of a barcode or a QR code.

5. The method of claim 1, further comprising establishing mutual trust between the KLD and the HSM based on the extracted attribute.

6. The method of claim 1, wherein the secure connection is a transport layer security (TLS) connection.

7. The method of claim 1, wherein the custom certificate consists of non-sensitive information.

8. The method of claim 7, wherein the attribute is one of an IP address or a public key associated with the HSM.

9. The method of claim 1, further comprising receiving, at the key manager, an indication of the HSM, wherein the display of the machine-readable code is responsive to the received indication.

10. The method of claim 1, wherein the HSM is associated with a set of HSMs, and wherein the key manager is configured to display a unique machine-readable code for each HSM in the set of HSMs.

11. A key management system, comprising:
a HSM comprising a processor configured to generate a custom certificate including non-sensitive information associated with the HSM;
a key manager device communicatively coupled to the HSM and comprising a display and a processor configured to generate a machine-readable code of the custom certificate, wherein the key manager selectively displays the machine-readable code on the display in response to a key ceremony request; and
a key loading device comprising an optical reader and a processor configured to scan the machine-readable code using the optical reader, extract the non-sensitive information from the machine-readable code, and establish a secure connection with the HSM using the non-sensitive information.

12. The system of claim 11, wherein the HSM is further configured to encrypt the custom certificate.

13. The system of claim 12, wherein the KLD is further configured to decrypt the custom certificate using a private key stored on the KLD.

14. The system of claim 11, wherein the machine-readable code is one of a barcode or a QR code.

15. The key management system of claim 11, further comprising establishing mutual trust between the KLD and the HSM based on the extracted non-sensitive information.

16. The system of claim 11, wherein the secure connection is a transport layer security (TLS) connection.

17. The system of claim 11, wherein the non-sensitive information includes an IP address or a public key associated with the HSM.

18. A method of establishing a secure connection for a key ceremony, the method comprising
generating, at each hardware security module (HSM) of a plurality of HSMs, a custom certificate including non-sensitive information associated with the respective HSM;
receiving, at a key manager, a request to generate a set of key components, wherein the request includes an indication of an HSM of the plurality of HSMs;
generating, by the key manager, a machine-readable code encoding the custom certificate associated with the HSM;
displaying, by the key manager, the machine-readable code;
scanning the machine-readable code with a key loading device (KLD);
decoding, at the KLD, the non-sensitive information associated with the HSM from the scanned machine-readable code; and
initiating, from the KLD, a secure connection with the HSM based on the non-sensitive information, wherein the secure connection is configured to support the exchange of the set of key components.

19. The method of claim 18, further comprising encrypting, at each HSM of the plurality of HSMs, the respective custom certificate.

20. The method of claim 19, further comprising decrypting, at the KLD, the custom certificate using a public key of the HSM stored at the KLD.
